(19) United States
(12) Patent Application Publication
(10) Pub. No.: US 2015/0248339 A1
(43) Pub. Date: Sep. 3, 2015

(54) SYSTEM AND METHOD FOR ANALYZING A STORAGE SYSTEM FOR PERFORMANCE PROBLEMS USING PARAMETRIC DATA

(71) Applicant: NetApp, Inc., Sunnyvale, CA (US)

(72) Inventors: Vipul Mathur, Bangalore (IN); Swaminathan Ramany, Bangalore (IN); Cijo George, Bangalore (IN)

(73) Assignee: NetApp, Inc., Sunnyvale, CA (US)

(21) Appl. No.: 14/194,467

(22) Filed: Feb. 28, 2014

(51) Int. Cl. G06F 11/30

(52) U.S. Cl. CPC G06F 11/3034

(57) ABSTRACT

Analysis is performed on a collection of data that is recorded for the storage system during a first time frame. The recorded collection of data includes a plurality of performance parameters that are determined from, for example, diagnostic tools that continually operate on the storage system. A set of baseline values are determined for each of the plurality of performance parameters by analyzing the recorded collection of data from an older portion of the time frame. For each parameter, a set of performance parameter values obtained from a recent portion of the time frame is compared to a corresponding baseline value of that performance parameter. From performing the comparison, one or more anomalies that are indicative of a particular problem on the storage system are determined for one or more of the plurality of performance parameters.

### TECHNICAL FIELD

Examples described herein include a system and method for analyzing a storage system for performance problems using parametric data.

### BACKGROUND

Data storage environments are increasingly more complex and intricate. As a consequence of the increase in size and complexity, the ability to troubleshoot performance issues in the storage systems has also become more difficult. Often, performance problems are not detected until significant time has passed from an underlying issue (e.g., a failure of a particular component). As a result, diagnosing an underlying problem with a particular storage system is a challenging task, given the passage of time to when the problem becomes detectable, and the size and complexities of the affected system.

Currently, expert-centric processes are heavily relied upon in order to diagnose performance problems in storage systems. Generally, metrics are gathered about the system in question, and human experts manually sift through the data to detect various levels of evidence regarding possible causes of a performance problem. Once a performance problem is identified, the expert recommends a possible course of action to work around the cause of the issue. The success of the process depends heavily on the availability and abilities of the human experts. In industrial settings, often various levels of such manual assessments are done to triage the common reoccurring issues quickly at the first level, while more difficult issues are escalated to more proficient or specialized experts. One consequence of such processes is that there is a significant time delay between when a problem is resolved and when the problem was first reported. Another consequence of such processes is that the resolution is often only as good as the availability of the expert who was selected to assist in resolving the problem.

### BRIEF DESCRIPTION OF THE DRAWINGS

FIG. 1 illustrates a system for analyzing a storage system to detect faults that negatively impact performance, according to an embodiment.

FIG. 2 illustrates a method for using performance parameters to determine a component and instance of time when a fault occurred within a storage system, according to an embodiment.

FIG. 3 illustrates a method for using performance parameters within a defined period of time in identifying a component and time when a fault occurred within a storage system, according to an embodiment.

FIG. 4 is a block diagram that illustrates a computer system upon which embodiments described herein may be implemented.

### DETAILED DESCRIPTION

Embodiments described herein include a system for analyzing parametric data in order to speed up diagnosis of performance problems on the storage system by automatically detecting the time when a problem occurs and the components that are affected. As described in greater detail below, individual parameters are analyzed in order to determine baseline values for each parameter that are specific to particular time periods. More recent values for individual parameters can be compared to corresponding baseline values at corresponding times in order to determine anomalies which can be indicative of an underlying component, resource or entity that is affected by a performance problem.

Among other benefits, embodiments described herein enable a data-driven and programmatic process to diagnose and trouble-shoot performance problems in complex storage systems and data networks. Some examples described herein leverage existing technology to obtain parametric data from a given storage system. Embodiments described herein facilitate diagnosing components or entities of the storage system which fail or perform poorly, by significantly reducing the time needed to identify the source underlying a performance issue on the storage system.

Examples described herein provide a system and method for analyzing a storage system. In an embodiment, analysis is performed on a collection of data that is recorded for the storage system during a first time frame. The recorded collection of data includes a plurality of parameters that are determined from, for example, diagnostic tools that continually operate on the storage system. A set of baseline values are determined for each of the plurality of parameters by analyzing the recorded collection of data from an older portion of the time frame. For each parameter, a set of parameter values obtained from a recent portion of the time frame is compared to a corresponding baseline value of that parameter. From performing the comparison, one or more anomalies that are indicative of a particular problem on the storage system are determined for one or more of the plurality of parameters.

According to some embodiments, a component, resource or entity of the storage system can also be determined as significantly affected by the particular problem of the storage system. The determination can be based on the one or more anomalies.

Still further, in some embodiments, a time during the recent portion of the first time frame is also determined, coinciding with when the component, resource or entity became affected by the performance problem. The determination can be based on the one or more anomalies.

In some embodiments, the set of baseline values of each parameter includes a baseline value for each moment of a pre-determined time period within the time frame. The value of each parameter at each moment of the pre-determined time period is compared with a corresponding baseline value for that parameter at the same moment of the pre-determined time period. The pre-determined time period can correspond to, for example, a week.

In some embodiments, the determination of the anomalies can include comparing the value of the parameter at each moment of the pre-determined time period with a corresponding baseline value for that parameter at the same interval of the pre-determined time period.

Example such as described herein recognize that conventional expert-centric processes to diagnose performance problems on data centers and enterprise networks are relatively inefficient, and scale poorly relative to the propensity of networks to increase in complexity and size. Among other benefits, examples such as described herein employ data gathering processes and tools in order to automate much of the initial analysis and task performance involved in problem diagnoses and resolution on a storage system.

As used herein, the terms “programmatic”, “programmatically” or variations thereof mean through execution of code, programming or other logic. A programmatic action may be performed with software, firmware or hardware, and generally without user-intervention, albeit not necessarily automatically, as the action may be manually triggered.

One or more embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component can exist in a hardware component independently of other modules/components or a module/component can be a shared element or process of other modules/components, programs or machines. A module or component may reside on one machine, such as on a client or on a server, or may alternatively be distributed among multiple machines, such as on multiple clients or server machines. Any system described may be implemented in whole or in part on a server, or as part of a network service. Alternatively, a system such as described herein may be implemented on a local computer or terminal, in whole or in part. In either case, implementation of a system may use memory, processors and network resources (including data ports and signal lines (optical, electrical etc.)), unless stated otherwise.

Furthermore, one or more embodiments described herein may be implemented through the use of instructions that are executable by one or more processors. These instructions may be carried on a non-transitory computer-readable medium. Machines shown in figures below provide examples of processing resources and non-transitory computer-readable mediums on which instructions for implementing one or more embodiments can be executed and/or carried. For example, a machine shown for one or more embodiments includes processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and tablets) and magnetic memory. Computers, terminals, and network-enabled devices (e.g. portable devices such as cell phones) are all examples of machines and devices that use processors, memory, and instructions stored on computer-readable mediums.

System Overview

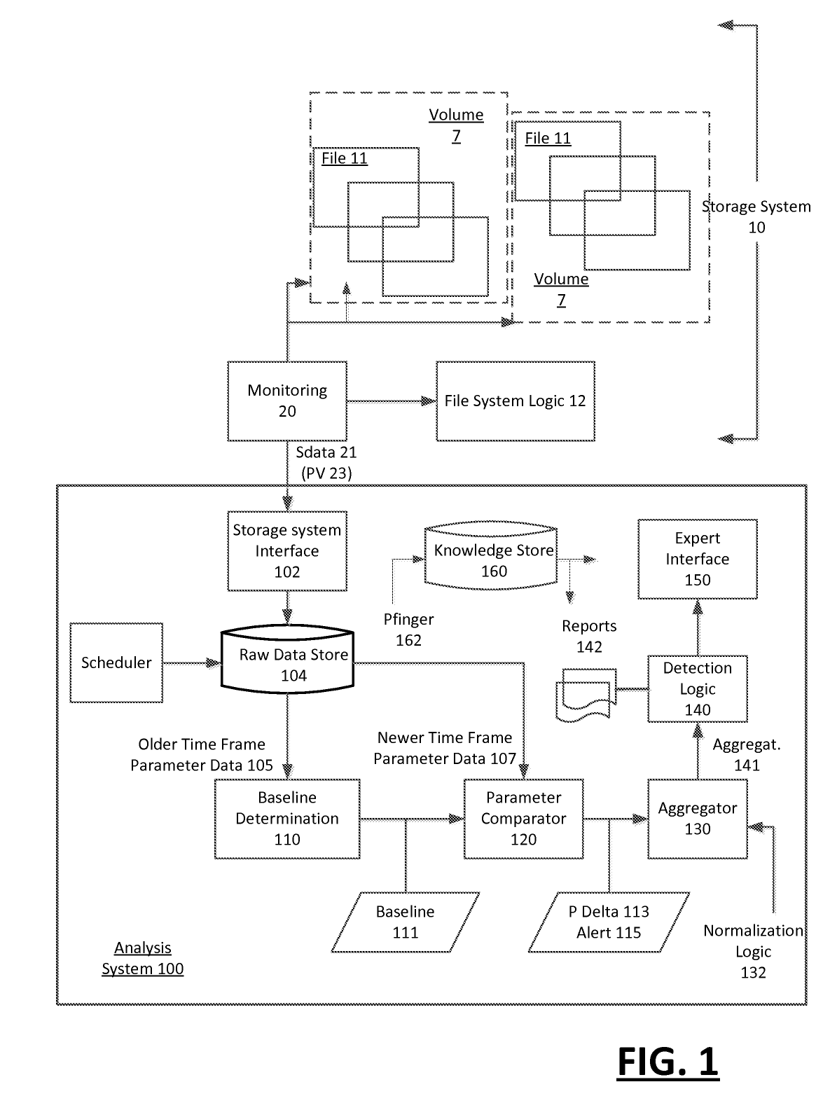

FIG. 1 illustrates a system for analyzing a storage system to detect faults that negatively impact performance, according to an embodiment. An analysis system 100 such as shown by an example of FIG. 1 can be implemented in the context of a network environment, such as in connection with the use of a data center. In an example of FIG. 1, the analysis system 100 can be provided as an independent service that communicates with a network environment on which a storage system 10 is provided. In a variation, analysis system 100 can be provided as a service or component within the network environment of the storage system 10. As described in greater detail, the analysis system 100 can receive parametric values from the storage system 10, and analyze those parametric values in order to identify specific components or entities of the storage system 10 that are not performing, or not performing well. The storage system 10 can employ, for example, large-scale clusters that includes complex interdependencies of various components.

Examples further recognize that, given the complexities of storage systems 10, the fault of a component, resource or entity on storage system 10 can result in a time-delayed performance issue that is not detected or reported until weeks later. In particular, the negative impact stemming from a poor or non-performing component or entity typically propagates in the storage system 10, until a point is reached where the issue is detectable (e.g., noticeable to end users). At this point, diagnosing the source of the problem is more difficult, particularly under conventional approaches, as numerous components are affected, and further as considerable amount of time has passed (e.g., days or weeks) since when the original problem occurred. Among other benefits, examples described herein can pinpoint both a source and time for when a problem on the storage system 10 arises.

In an example of FIG. 1, the storage system 10 can include a file system that provides multiple volumes 7, each of which included collection of files 11. By way of example, the file system can be implemented to process communications from clients using, for example, NFS version 3.

In one implementation, the storage system 10 includes a monitoring component 20 that implements multiple processes for determining parametric values about individual components or entities of the storage system 10. The monitoring component 20 can be conventionally implemented to obtain, for example, AutoSupport data (ASUP), using tools such as PerfStat (manufactured by Netapp Inc.). Multiple types of tools can be employed as the monitor component 20, including tools from the digital signal processing, time series analysis and statistical domains. Such tools are conventionally employed to run in the storage system 10 to gather fine-grained data after a performance problem has been reported. The monitoring component 20 can output system data 21 (e.g., ASUP data) to the analysis system 100. The system data 21 can include parametric values 23 obtained from the monitoring component 20, or other tool, such as diagnostic or testing tools.

In an example of FIG. 1, the analysis system 100 includes a storage system interface 102, a raw database 104 a baseline determination component 110, a parametric comparator 120, and an aggregator 130. The storage system interface 102 receives the system data 21 from the monitoring component 20, operating the storage system 10. In one implementation, the system data 21 (including parametric values 23) is stored in the raw database 104. A scheduler 106 maintains a schedule 109 that defines the time frame for which analysis can be done for the storage system 10 at a particular instance. The schedule 109 specifies each of an older and newer or recent portion of the time period. In one implementation, the more recent portion of the time frame corresponds to a full time period (e.g., week), and the older portion of the time frame corresponds to several time periods (e.g., multiple weeks). For example, the scheduler 106 maintains a five-week schedule, so that a preceding 5 weeks of data is identified and available for use at any given moment. The schedule input 109 from the scheduler 106 can serve to structure or otherwise organize data in the raw database 104, so that data is identifiable for the entire designated time frame. Moreover, as described below, the time frame can be split into an older portion (e.g., first four weeks) and a newer portion (e.g., most recentl week). The scheduler 106 can identify the older and newer portions of the schedule 109, and further organize or otherwise structure the raw database 104 to separately identify the data that is part of both the older portion and newer portion of the first time frame.

The baseline determination component 110 uses the parametric values as obtained from the system data 21 in order to determine a baseline dataset 111. The baseline dataset 111 can include baseline parameter values for each parameter identified by the diagnostic tools operating on the storage system 10 (e.g., monitoring component 20).

According to some embodiments, the baseline determination component 110 obtains parametric values 105 from the older portion of the timeframe maintained by the scheduler 106. The baseline determination component 110 seeks to determine baseline values for each individual parameter in the system data 21. Examples described herein recognize that parametric values that are deemed normal among storage systems vary considerably, based on aspects and characteristics that are specific to a particular network environment. Accordingly, the baseline determination component 110 uses parametric values 105 identified during the older portion of the first time frame in order to determine “normal” (or baseline values) for individual parameters within the particular storage system 10.

In one embodiment, the baseline determination component 110 determines baseline values for individual parameters by comparing (e.g., averaging) values of a parameter at defined moments within the time period (e.g., week) of the time frame (e.g., 5 week period). By way of comparison, the baseline determination component 110 compares the value of a particular parameter at a same time and same day across multiple weeks that comprise the older portion of the time frame. The parameter-specific comparison is made for each parameter, so that an expected value of a particular parameter at a given instance in a time period is known. This expected value can correspond to the baseline value for a particular parameter. In this regard, the baseline value for a particular parameter can correspond to multiple expected values, each of which can correspond to a particular time of the defined time period. In this way, the baseline values of a particular parameter can vary over the course of the defined time period (e.g., week). As described, the examples described herein recognize that parametric values can vary based on time and date, but generally the parameter values are relatively the same given a particular moment in time in a day or a week.

In this way, the baseline determination component 110 determines a set of baseline values 111 for each parameter of the system data 21. The parametric comparator 120 uses the set of baseline values 111 in order to identify those parameters which exhibit anomalies in the recent portion of the time frame. In particular, the parametric comparator 120 receives parameter data 107 from the recent portion of the time frame, in which each parameter of the system data 21 includes multiple values spanning the more recent portion of the time frame (e.g., most recent week). The parameter data 107 can follow a same time period as that used in the older portion. For example, the parameter values 105 can represent hourly parameter data for the first four entire weeks of the time frame, and the parameter data 107 can represent parameter data for the most recent week of the time frame. The comparison made by the parametric comparator 120 includes comparing the value of each parameter at each determined instance of the defined time period in the recent portion of the time frame (e.g., hour of week day in more recent portion) to a corresponding baseline value for that parameter at that same instance of the defined time period (e.g., at same hour and week day of week). For example, the value of a given parameter at 8 pm on Monday evening is compared to a baseline value for that parameter that is specific to 8 PM on Monday evening.

As an alternative or variation, the comparison performed by the parametric comparator 120 can include comparing the value of each parameter at each determined instance of the defined time period in the recent portion of the time period to a baseline value for a relevant instance in the time period. By way of example, the value of a given parameter at 8 PM on Monday can be compared to a baseline value for evenings (e.g., between 6 PM and 9 PM), or to evenings on weekdays.

The comparison performed by the parametric comparator 120 can identify anomalies. Anomalies can be defined as those parameter values which differ from the corresponding baseline by some pre-determined threshold, (e.g., 10%). An output of parametric comparator 120 includes an anomaly data collection 115 including identification of (i) parameters which have values that are anomalies, and (ii) a time in the period when those anomalies occurred.

Embodiments recognize that in a complex data storage system 10, numerous anomalies can occur without an underlying cause or problem. Generally, an assumption can be made that an underlying problem (e.g., poorly performing component) causes anomalies with respect to multiple parameters. Accordingly, in order to detect when anomalies represent an underlying problem or fault, the parametric values can be combined or aggregated so that significant anomalies can be ascertained. In an example of FIG. 1, the aggregator 130 can combine parametric values, and in particular, those parametric values that are anomalies. Additionally, the aggregator 130 can aggregate anomalies of parametric values in specific instances of time (e.g., each hour) in the recent portion of time.

In performing aggregation, the aggregator 130 can normalize parameters into a common range of numbers (e.g., between 0 and 1). Such normalization can make the parameter values unit-less. The aggregator 130 can utilize normalization logic 132 to normalize the parametric vales, so an aggregation can be determined for parametric values that originally contained differing units. The normalization logic 132 can include for example, parameter-specific coefficients that render an individual parameter unit-less and within a pre-determined range of values (e.g., between 0 and 1).

In one implementation, the aggregation component 130 can aggregate normalized anomalies for parameters that are deemed relevant to one another. The aggregation can involve the following: (i) normalizing parameters to be unit-less and/or within a common range of values; (ii) aggregating anomalous parameters at common instances of time (e.g., cluster parameter values taken at the same time/day); (iii) aggregating parameters that are relevant to one another; and/or (iv) generating multiple aggregations that share common parameter values (e.g., a single parameter can be included in multiple aggregations). In this way, the anomalous parametric values for components that are inter-related or part of a common system can be combined in order to determine when the aggregate of multiple parameters is significant. For example, individual aggregations 141 can be comprised of parameters that collectively represent an individual component, a process, a protocol shared by multiple components, a sub-system that affects multiple components, or a volume or the system as a whole. In this way, the detection logic 140 can use aggregated values 141 (or aggregation 141), corresponding to aggregation of normalized values for parameters that are deemed anomalous. The aggregations 141 provided for the detection logic 140 can further be time-stamped to reflect the time when the parametric components of the particular aggregation were obtained.

The detection logic 140 can detect when the aggregate of multiple parameters is above a particular pre-defined threshold, in which case the individual anomalies of the aggregation can be deemed significant. By way of example, anomalies in parametric values can be represented as coefficients between 0 and 1, and the detection logic 140 can deem an aggregation 141 significant when the value of the aggregation exceeds a predetermined threshold. The threshold can be specific to the aggregation 141 (e.g., the cluster of parametric values for a particular component, system, volume or inter-dependent collection of components). The detection logic 140 can process multiple aggregations in order to determine those aggregates 141 which are significant.

When particular aggregations 141 are deemed significant, the detection logic 140 can include logic to link the aggregations to a specific component, resource or entity within the storage system 10. For example, the detection logic 140 can associate aggregations 141 with corresponding components or entities, and those aggregations 141 which are deemed significant can be linked to an appropriate component, resource, set of components and/or entity or entities. Additionally, the detection logic 140 can process time stamps associated with aggregations 141 in order to determine time values for when aggregations become significant.

The detection logic 140 can combine with the aggregator 130 to provide reports 142. The reports can be based on the aggregations 141. The reports 142 can identify aggregations 141 which are deemed significant, as well as components or entities of the significant aggregations. According to some embodiments, the reports 142 can include data that is indicative of a component, resource or entity of the storage system 10 which encounters a problem. Additionally, based on the time stamps that are associated with the individual aggregations 141, the reports 142 can include data that is indicative of when the fault initiated. As an addition or alternative, an expert interface 150 can enable an expert to view data that is otherwise provided through the reports 142.

According to some embodiments, the analysis system 100 includes a knowledge data store 160 that stores data that correlates to specific determined faults of storage systems in general. Data indicative of a particular component, resource or entity that is problematic can be stored in the knowledge store 160 for future use in troubleshooting the particular storage system 10, or other storage systems. In an embodiment, the knowledge data store 160 stores problem fingerprint data 162, corresponding to anomalous parametric values, aggregations and derivatives thereof, which are deemed to be highly indicative of a particular problem (e.g., component failure). The knowledge data store 160 can store an accumulation of problem fingerprint data 162 from prior and current analysis of storage systems and other networks, thereby providing a library that correlates known types of problems with data that is indicative of the particular problem. In this way, the knowledge store 160 can provide a heuristic or accumulated data source for troubleshooting performance related issues of storage systems on an ongoing basis.

Still further, the system 100 can store the baseline values for the storage system 10, and then reuse the baseline values for the system at future instances. In this way, the determination of baseline values can on be omitted or skipped in one or more follow on instances.

Methodology

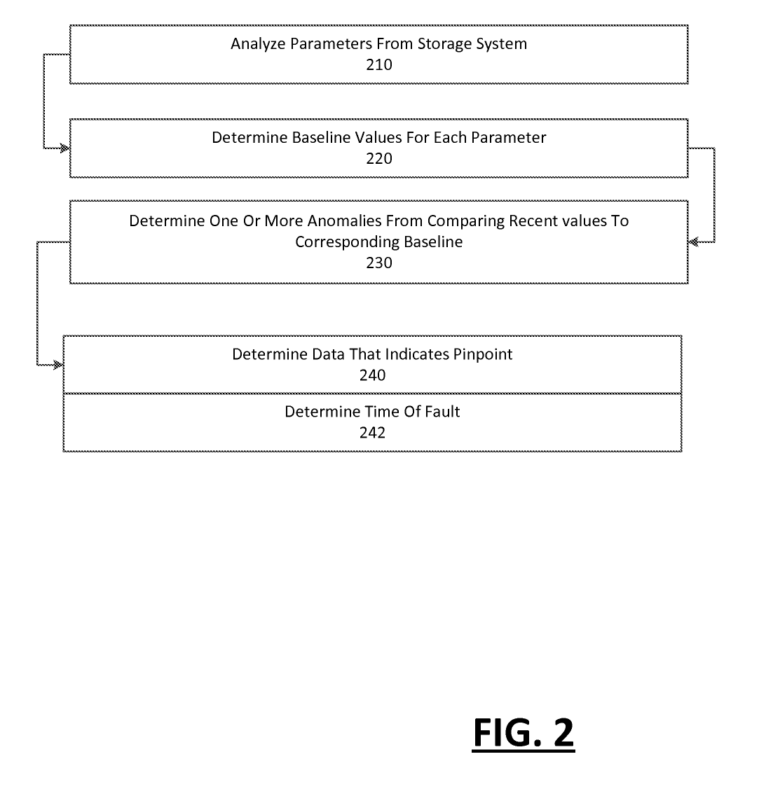

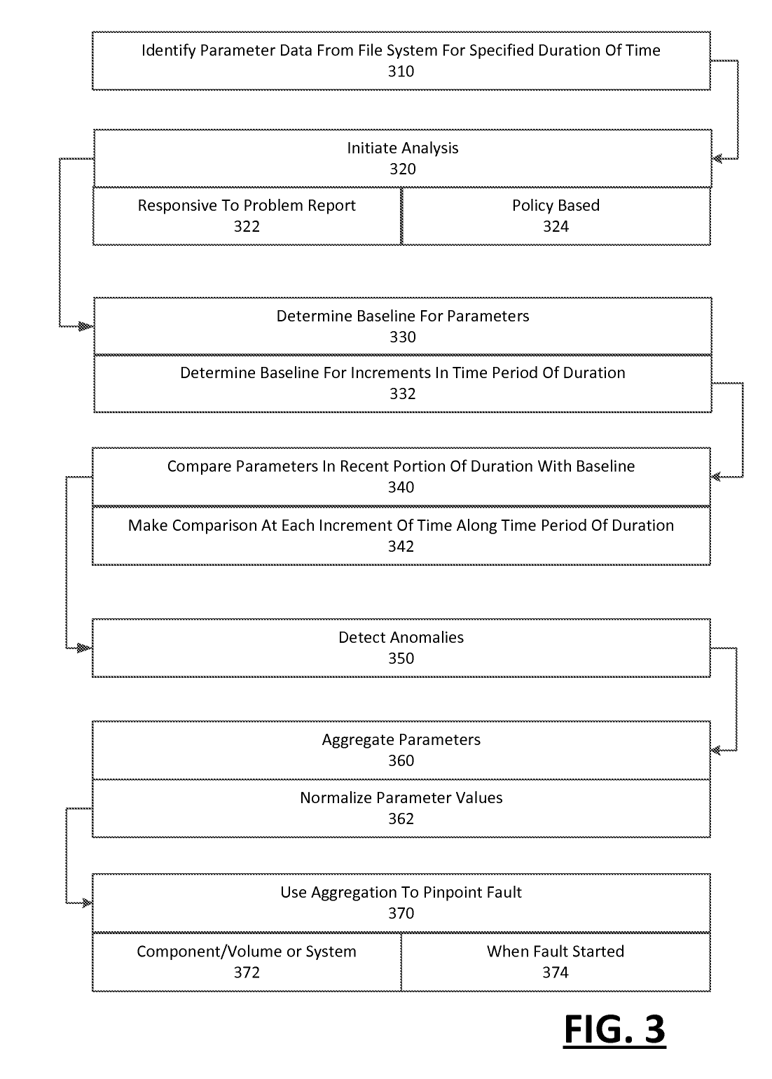

FIG. 2 illustrates a method for using performance parameters to determine a component and an instance of time when a fault occurred within a storage system, according to an embodiment. FIG. 3 illustrates a method for using performance parameters within a defined period of time in order to identify a component and time when a fault occurred within a storage system, according to an embodiment. In describing an example method of FIG. 2 or FIG. 3, reference may be made to elements of FIG. 1 for purpose of illustrating a suitable component or element for performing a step or sub-step being described.

With reference to FIG. 2, the values for a collection of parameters of a storage system are obtained (210). For example, an analysis system 100 can obtain parameters regarding the performance of components or entities of the storage system 10 from a diagnostic tool.

A baseline is determined for a value of each parameter of the collection (220). The baseline may be based on, for example, an average. Furthermore, multiple values can be determined at the baseline for each parameter, each of which correlate with an instance of time along a time period during which the parametric data is obtained.

One or more anomalies are identified by comparing recent values of individual parameters with corresponding baseline values (230). The comparisons with baseline values can be made for individual parameters and at coinciding instances of time along the time period during which the parametric data is obtained.

From the anomalies, data is generated that is indicative of a pinpoint for a fault of the storage system (240). The pinpoint can correspond to a component, resource or entity. Additionally, the pinpoint can correspond to a time when the component, resource or entity failed or became problematic (242).

In one implementation, the pinpoint data is communicated to an expert via the expert interface 150. As another example, the pinpoint data can be communicated to an administrator of the network on which the storage system 10 is provided.

With reference to an example of FIG. 3, parametric data is obtained from the storage system 10 at specified interfaces over the course of a given time frame. In one implementation, the storage system 10 implements the monitoring component 20 to continually collect system data 21, including parametric values 23. The parametric values 23 can be collected on the network of the storage system 10 and communicated to a remote or external service (e.g., operated by vendor for storage system 10). Alternatively, the parametric values 23 can be collected and processed within the network of the storage system 10.

An analysis of the parametric values can be initiated to identify faults within the storage system 10 (320). In one implementation, the analysis can be triggered in response to performance issues arising on the storage system (322). For example, the analysis of the parametric values can be initiated in response to performance problems becoming noticeable to users of the storage system 10. In a variation, the analysis is performed based on a pre-determined policy (324). For example, the analysis can be initiated automatically, based on a schedule or in response to certain conditions.

The baseline for the parametric values is determined (330). In an embodiment, the baseline is determined by (i) collecting parametric values for the time frame, and (ii) determining normal parametric values at an older portion of the time frame. By way of example, the parametric values can be collected for a preceding 5 week period, and the baseline values can be based on a range or average of parametric values in the first 4 weeks of that time frame.

Each parameter that is measured on the storage system 10 can have its own baseline value or range. Additionally, individual parameters can have multiple baseline parameter values, corresponding to different times in the time frame when the parameter was measured or otherwise determined (332). For example, the time frame in which parametric values are obtained (310) can span several weeks (e.g., 5 weeks), and a defined time period can correspond to a single week. A baseline can be determined for each parameter at a specific time in the defined time period (e.g., at a specific hour and day of the week). The baseline values for each parameter can be based on the older portion of the time frame (e.g., the preceding weeks prior to the recent week) in which the parametric values are obtained.

Once the baseline is determined for individual parameters at different instances of a defined time period, a comparison is made as between the values of individual parameters obtained in a recent portion of the time frame (e.g., within the immediately prior recent weeks), and the baseline value for that parameter (340). The comparison of parametric values can be specific to baseline values for an hour and day of a week (342). More specifically, the baseline parameter can correspond to the value of that parameter at a corresponding instance of in the defined time period (each week). By way of example, parametric values can be obtained for a duration of time that extends 5 weeks prior from when a problem is detected on the storage system 10. The first 4 weeks of that time frame can be used to obtain baseline values for each parameter. The baseline values can be obtained for each measured instance of the week. For example, the parameter values can be obtained for each hour of each day in a given week, and the baseline values can be considered reflective of what parameters should be (or can be expected to be) for any following week. The comparison between the values of the parameter in the recent portion of the time frame (the 5^{th} week of the 5-week time frame) can be made for individual instances of the defined period. Thus, for example, parametric values at each hour of the more recent week can be compared to baseline parametric values for the same hour and day of the week.

Based on the comparison, anomalies are detected for individual parameters (350). The anomalies can be specific to in instance along the defined time period (e.g., week), and can correspond to when a parameter value in the more recent week exceeds a range or value of the baseline value, or alternatively, exceeds a range or value by some threshold (e.g. 10%). In one embodiment, the threshold or condition for when a parametric value is deemed an anomaly is pre-determined and made specific to the parameter using, for example, rules or other logic. For example, some parameters can be deemed anomalies if the parametric value measured in the recent week exceeds the baseline value by a first percentage, while other parametric values can be defined to be anomalies if they exceed the baseline value by a greater percentage. Such parametric specific conditions for when parameters are deemed anomalies can accommodate, for example, parameters which tend to fluctuate more than others.

According to some embodiments, the aggregations are determined from anomalous parametric values (360). The use of aggregations can serve to filter random fluctuations among parametric values. Multiple aggregations can be defined and formed from parametric values that are deemed anomalies, and one parametric value can be included with multiple different aggregations. In this way, the aggregations can be used to determine a context for the anomalies in the storage system 10.

Examples described herein recognize that once baseline values are determined for a system, the baseline values can be stored and then reused. Thus, an example of FIG. 3 can be implemented as a first instance for a particular network, and on some subsequent instances, the baseline values for the network can be reused. At some point, a determination may be made or assumed that the baseline values are stale, and re-determination can be performed using an example such as described with FIG. 3.

Still further, examples described herein recognize the parametric values often represent physical measurements that have different units, scales, and or definitions. Normalization logic can be utilized in order to normalize parametric values into a unit-less value that spans a common yet meaningful range of values. For example, each parametric value that is deemed an anomaly can be normalized into a coefficient between 0 and 1 that is unit-less. In order to normalize a parametric value, each parameter can be associated with and multiplied against a normalization counterpart that both scales and renders the coefficient unit-less. The normalization logic can maintain a list of normalization counterparts, each of which is paired to a corresponding coefficient obtained from the storage system 10. In this way, the aggregation can be in the form of a unit-less number that includes components stemming from multiple anomalous parametric values.

The aggregations that are determined from the anomalous parametric values can be analyzed to pinpoint faults in the storage system 10 (370). The analysis can be made programmatically and or manually. In one implementation, the aggregations identify data that is indicative of a particular component, resource, or entity that is problematic or performing poorly (372). In this way, the pinpoint can be specific to a component, a volume or can be system-wide.

In addition to identifying a particular component, resource or entity as significantly involved in a problem, the fault detection can further be pinpointed to a particular time, or range of time (374). The fault detection time can precede when the detection of a problem is first noticed. For example, the fault detection time can precede when a user notices performance issues by several days.

Among other benefits, examples such as described enable an expert to troubleshoot and pinpoint the faults underlying the performance issues of the storage system 10 in a manner that is far less time consuming, and requiring significantly less forensic detection to troubleshoot.

Computer System

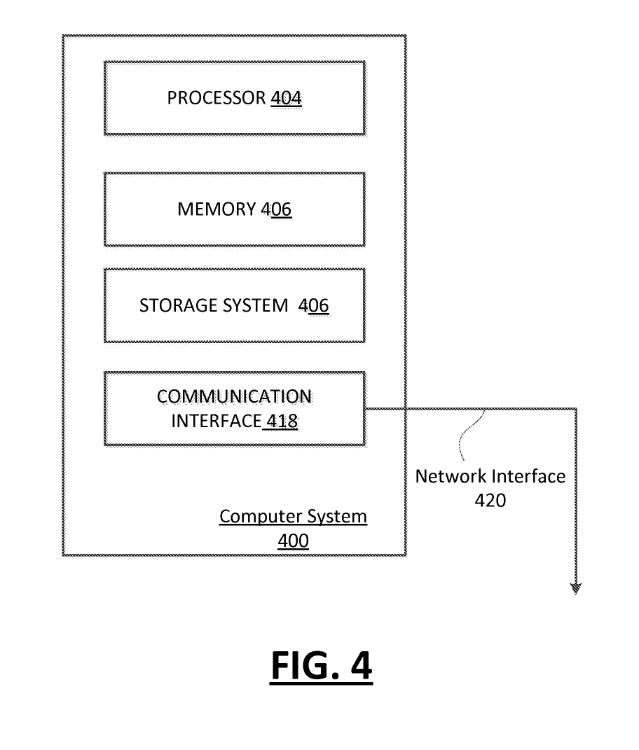

FIG. 4 is a block diagram that illustrates a computer system upon which embodiments described herein may be implemented. For example, a system such as described with FIG. 1 can be implemented on a computer system such as described with an example of FIG. 4. Likewise, a method such as described with an example of FIG. 2 or FIG. 3 can also be implemented using a system such as described with FIG. 1.

In an embodiment, computer system 400 includes processor 404, memory 406 (including non-transitory memory), storage device 410, and communication interface 418. The memory 406 can include random access memory (RAM) or other dynamic storage resources, for storing information and instructions to be executed by processor 404. The memory 406 also may be used for storing temporary variables or other intermediate information during execution of instructions to be executed by processor 404. The memory 406 may also include a read only memory (ROM) or other static storage device for storing static information and instructions for processor 404. A storage device 410, such as a magnetic disk or optical disk, is provided for storing information and instructions. The communication interface 418 may enable the computer system 400 to communicate with one or more networks through use of the network link 420 (wireless or wireline).

In one implementation, memory 406 may store instructions for implementing functionality such as described with an example of FIG. 1, or implemented through an example method such as described with FIG. 2 or FIG. 3. Likewise, the processor 404 may execute the instructions in providing functionality as described with a system such as described with FIG. 1, or with methods such as described with FIG. 2 or FIG. 3.

Embodiments described herein are related to the use of computer system 400 for implementing the techniques described herein. According to one embodiment, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for analyzing a storage system, the method being implemented by one or more processors and comprising:
(a) analyzing a recorded collection of data for the storage system during a first time frame, the recorded collection of data including a plurality of performance parameters for the storage system;
(b) determining, from analyzing the recorded collection of data during an older portion of the first time frame, a set of baseline values for each of the plurality of performance parameters;
(c) for each of the plurality of performance parameters, comparing a set of values for that performance parameter in a recent portion of the first time frame to a corresponding baseline value of that performance parameter; and
(d) determining, by comparing the set of values for each performance parameter in the recent portion of the first time frame to the corresponding baseline value of that performance parameter, one or more anomalies in one or more of the plurality of performance parameters that are indicative of a particular problem on the storage system.

2. The method of claim 1, further comprising (e) identifying a component, resource or entity of the storage system that is a cause of the particular problem of the storage system.

3. The method of claim 2, wherein (e) includes determining a time in the recent portion of the first time frame when the component, resource or entity failed or started to perform poorly.

4. The method of claim 1, wherein the set of baseline values for each performance parameter includes a baseline value for each moment of a pre-determined time period within the time frame, and wherein comparing the set of values for each performance parameter includes comparing the value of the performance parameter each moment of the pre-determined time period with a corresponding baseline value for that performance parameter at the same moment of the pre-determined time period.

5. The method of claim 4, wherein the pre-determined time period corresponds to a week, and wherein (b) includes determining the baseline value for the performance parameter at defined intervals of the week.

6. The method of claim 5, wherein comparing the value of the performance parameter at each moment of the pre-determined time period with a corresponding baseline value for that performance parameter at the same interval of the pre-determined time period.

7. The method of claim 1, further comprising recording data corresponding to a plurality of performance parameters for the storage system.

8. The method of claim 1, wherein (a)-(d) are performed in response to detecting a performance shortcoming of the storage system.

9. The method of claim 1, wherein individual parameters are expressed in units that differ from one or more of the other parameters in the plurality parameters, and wherein the method further comprises normalizing a value of each of the plurality of performance parameters to be unit-less and within a pre-determined scale.

10. The method of claim 1, wherein (d) includes determining data that identifies (i) the specific component, resource or entity as being a cause of a performance problem with the storage system, and (ii) a time in the recent portion when the component, resource or entity failed or started to perform poorly.

11. The method of claim 1, wherein (d) includes determining data that identifies a specific time when the one or more anomalies occurred.

12. The method of claim 1, wherein recording data corresponding to the plurality of performance parameters includes periodically recording data pertaining to specific parameter values of the storage system on (i) a system-level and (ii) a subsystem and/or component level.

13. The method of claim 1, wherein recording data corresponding to the plurality of performance parameters includes receiving data from a utilities component installed on the storage system to monitor operation of one or more components or entities of the storage system.

14. The method of claim 1, wherein (c) includes comparing the value of each performance parameter in the plurality of performance parameters at multiple instances of time during a day of a week of a recent week of the first time frame to baseline value for each of the multiple instances of time during the day of the week in multiple prior weeks of the first time frame.

15. The method of claim 14, wherein (d) includes determining when a value of a given parameter in the plurality of performance parameters varies in the recent portion of the first time frame by an amount that is greater than a threshold as compared to a corresponding baseline value for that performance parameter.

16. The method of claim 1, wherein (d) includes aggregating multiple values for parameters in the plurality of performance parameters at each of multiple instances in the recent portion of the first time frame in determining determine when an anomaly of a particular parameter is significant.

17. The method of claim 1, further comprising storing data in a knowledge library that correlates anomalies that are determined for individual parameters in the plurality of performance parameters with specific faults that have been known to occur for analyzed storage systems.

18. The method of claim 1, wherein the older portion of the first time frame corresponds to a first multiple of a time period, and wherein the recent portion of the first time frame corresponds to a second multiple of the time frame, the second multiple being less than the first multiple.

19. A non-transitory computer-readable medium that stores instructions, the instructions being executable by one or processors to cause the one or more processors to perform operations that include:
(a) analyzing a recorded collection of data for the storage system during a first time frame, the recorded collection of data including a plurality of performance parameters for the storage system;
(b) determining, from analyzing the recorded collection of data during an older portion of the first time frame, a set of baseline values for each of the plurality of performance parameters;
(c) for each of the plurality of performance parameters, comparing a set of values for that performance parameter in a recent portion of the first time frame to a corresponding baseline value of that performance parameter; and
(d) determining, by comparing the set of values for each performance parameter in the recent portion of the first time frame to the corresponding baseline value of that performance parameter, one or more anomalies in one or more of the plurality of performance parameters that are indicative of a particular problem on the storage system.

20. A computer system comprising:
a memory resource that stores a set of instructions;
one or more processors that use instructions in the set of instructions to:
(a) analyze a recorded collection of data for the storage system during a first time frame, the recorded collection of data including a plurality of performance parameters for the storage system;
(b) determine, from analyzing the recorded collection of data during an older portion of the first time frame, a set of baseline values for each of the plurality of performance parameters;
(c) for each of the plurality of performance parameters, compare a set of values for that performance parameter in a recent portion of the first time frame to a corresponding baseline value of that performance parameter; and
(d) determine, by comparing the set of values for each performance parameter in the recent portion of the first time frame to the corresponding baseline value of that performance parameter, one or more anomalies in one or more of the plurality of performance parameters that are indicative of a particular problem on the storage system.
